(19) United States
(12) Patent Application Publication
(10) Pub. No.: US 2008/0023136 A1
(43) Pub. Date: Jan. 31, 2008

(54) ADHESIVE TAPES

(75) Inventors: Manfred Spies, Bad Bramstedt (DE); Zygmunt Kozaczka, Hamburg (DE)

Correspondence Address: NORRIS, MCLAUGHLIN & MARCUS, 875 THIRD AVE, 18TH FLOOR, NEW YORK, NY, 10022, US

(73) Assignee: TESA AG, Hamburg (DE)

(21) Appl. No.: 11/830,543

(22) Filed: Jul. 30, 2007

Related U.S. Application Data
(63) Continuation-in-part of application No. 10/853,821, filed on May 26, 2004.
(63) Continuation-in-part of application No. 10/043,670, filed on Jan. 11, 2002, now abandoned.

(30) Foreign Application Priority Data
Jan. 13, 2001 (DE) DE 101 01 335.3

(51) Int. Cl. B32B 7/12

(52) U.S. Cl. 156/326; 428/353; 428/355 BL

(57) ABSTRACT

An adhesive tape having a backing and an adhesive composition, wherein the adhesive composition is a styrene/butadiene dispersion having a butadiene content of more than 55% in a blend with natural rubber latex and has been coated onto the backing and then dried.

This application is a continuation-in-part of U.S. application Ser. No. 10/853,821 filed May 26, 2004 which is a Continuation-in-part of U.S. application Ser. No. 10/043,670 filed Jan. 11, 2002, which claims priority of German application number DE101 01 335.3 filed on Jan. 13, 2002.

### BACKGROUND OF THE INVENTION

The present invention relates to a pressure sensitive adhesive tape having cohesive composition systems based on styrene/butadiene latices of high butadiene content and natural rubber latex.

### DESCRIPTION OF THE RELATED ART

The conventional adhesive composition systems for pressure sensitive adhesive tapes are based substantially on natural rubber, styrene block copolymers, and polyacrylates. For applications where reversible behavior is a specific requirement, ethylene-vinyl acetates or poly-isobutylenes are also appropriate.

Styrene/butadiene latices have been used for many years in connection with pressure sensitive adhesives (PSA) for impregnating and stabilizing backing materials, especially papers, woven and non-woven materials. Because of their particular use, the impregnation or coating must be absolutely free of tackiness. It is therefore required that the styrene/butadiene copolymers used for this application contain a relatively high quantity of hardening monomers, but that they also include a sufficient quantity of softening monomer so that the copolymer remains overall still elastic. Styrene/butadiene latices having a butadiene content of about 25-55 Mol % fulfill this requirement very well. Films of these copolymers, depending on the butadiene content, are moderately elastic to elastic, and are non-tacky. Such copolymers have been available on the raw-material market for many years (Butofan®-type material is provided by BASF, and various materials are offered by Dow and Synthomer). Because of their preparation, such latices and dispersions include emulsifier systems to produce compatibility between the organic phase and the aqueous phase.

In the past, styrene/butadiene copolymers have also been used as base polymers for label compositions. In the labels sector, cohesion is often of secondary importance, so that the properties of weakly adhering systems are in many cases adequate after they have been compounded with customary tackifiers (resin dispersions).

Styrene:/butadiene copolymers have also been used in combination with natural rubber latices. An overview of this can be found in Donatas Satas, Handbook of Pressure Sensitive Adhesive Technology, 3rd Edition, Natural Rubber Adhesives by G. L. Butler (pp. 276-283).

In EP 95108577, Osari describes the use of aqueous emulsions based on natural rubber latex for producing pressure sensitive adhesive tapes. The addition of styrene/butadiene dispersions having a customary butadiene content (in the range of about 25-55 Mol %) serves primarily to stabilize the shear-unstable natural rubber latex and to set the viscosity.

The suitability of customary styrene/butadiene copolymers with a butadiene content of between 25 and 55% as framework polymers for cohesive PSA compositions is poor, since they always have to be made tacky using tackifier resins, in amounts which are considerable in some cases, which is associated with an extensive loss of cohesion. This prevents their use for adhesive tapes for which cohesive adhesive compositions are necessary.

Due to the polymer structure and pricing level, styrene/butadiene copolymers are of interest as framework polymers for demanding PSA compositions.

### SUMMARY OF THE INVENTION

It is an aspect of the invention to remedy this situation and to provide a styrene/butadiene-based adhesive composition which does not have the drawback of low cohesion and which can be used to make a pressure sensitive adhesive tape very suitable, inter alia, for reversible applications.

This aspect is achieved by the use of a styrene/butadiene dispersion of high butadiene content which has been blended with natural rubber latex. The resulting compound may be admixed, if desired, with further co-agents, such as aging inhibitors, UV stabilizers, fillers or emulsifiers, for example, in order to tailor further the protection against aging and the adhesion data to the application. After the adhesive composition is coated onto a polymer or paper backing, a pressure sensitive adhesive tape is obtained which meets the requirements for an adhesive tape having exceptional cohesive properties and which is suitable, for example, for reversible applications. Products of this kind may be employed in the field of surface protection. Furthermore, adverse effects are prevented on the cohesion of the adhesive compositions which are caused by tackifier resins. Residues caused by tackifier resins, as well, are therefore prevented during the detachment.

Accordingly, the adhesive composition of the present invention is prepared without any solvent and tackifier resins. Thus, the adhesive tape of the invention is water-based, made from of latex which is per se cohesive due to the educts. “Cohesive” in the context of the tape of the invention means that, upon removal of the tape, the adhesive layer remains cohesive, that is, it does not split. The internal adhesive forces are stronger than the external adhesive forces. Thus, no residual adhesive remains on the substrate to which the adhesive tape was adhered. This feature is obviously a great benefit, especially for packaging tapes. The known adhesives include adhesive compositions which, upon removal from an object, show that a portion of the adhesive has split off and a part of the adhesive remains on the object onto which the tape was placed

Adhesive Compositions:

The homopolymerization of styrene in an aqueous medium gives polymers whose high Tg gives them a very restricted importance even for paint applications. The copolymerization of styrene with about 35-45 Mol % butadiene in an aqueous medium gives copolymers which are film forming and in which a minimum film formation temperature of about 0° C. is achievable, so that these systems can be used in the sectors of priming, painting, binders, and general modification. The styrene/butadiene dispersions are generally stabilized by incorporating small amounts of carboxyl groups, which at the same time improves the adhesion to many substrates. As adhesive compositions for the invention it is possible in particular to use carboxylated styrene/butadiene copolymer dispersions having a butadiene a fraction of 55-95 Mol % preferably 60-85 Mol %, based on the total solids fraction of styrene and butadiene, which in a mixture with natural rubber latex exhibit outstanding suitability as adhesive compositions for reversible adhesive tapes. Carboxylated copolymers of this kind contain in particular less than 10 Mol %, preferably less than 5 Mol %, based on the monomer content, of carboxyl comonomer, especially acrylic acid, in the copolymer.

Styrene/butadiene dispersion grades used in accordance with the invention, having a butadiene content >60 Mol %, are available, for example, from Dow.

As the natural rubber latex component, both low ammonia latices and high ammonia latices are suitable. Latices of the low ammonia type are preferred. The definition for the concentration of ammonia (“high” and “low”) defined according to norm ISO 2004, specification 1997-11-00.

Based on the total solids content of styrene/butadiene copolymer and natural rubber latex, the natural rubber fraction should be in the range 5-80 Mol %, preferably 20-50 Mol %. For tailoring the adhesive properties it is also possible to use mixtures of different natural rubber latices. In order to improve the aging behavior it is possible to add dispersions of customary aging inhibitors and UV stabilizers, which are well known from the field of the elastomers.

It is also possible, where necessary, to add further additives for adapting the properties of the product, such as, for example, fillers or emulsifiers of the alkoxylated alkylphenol type, for example. These additives make it possible to exert further, desired influence over the adhesive properties.

Where necessary, the adhesion/cohesion balance may be set by chemical crosslinking via the carboxyl groups present, by means of added crosslinking agents such as aluminum chelate or titanium chelate, for example. In contrast to many styrene block copolymers, radiation crosslinking is likewise possible owing to the sufficiently high molecular weight. The adhesive blend is also physically crosslinkable by electron beam curing (EBC).

The adhesive composition application rate is 10-120 g/m², preferably 15-40 g/m².

Backing Materials:

All customary backing materials are suitable for the invention. They substantially include films and papers whose properties and whose production and/or after-treatment process gives them the required mechanical application properties.

In the case of the films, suitable materials substantially include polyethylene, polypropylene, polyvinyl chloride, polyesters, and other polymers and copolymers customary for the application, which may be used in single-layer or multilayer form. In multilayer systems, the composition and the thickness of the individual layers may also vary.

Both blown film and flat film may be used.

The thicknesses of the films are between 10 and 250 μm, preferably between 20 and 120 μm.

In order to ensure sufficient adhesion of the adhesive composition oil the backing material, the surface energy on the side that is to be coated must be situated within a defined range. This may be ensured either by additional coating with a primer or by a surface treatment. Preference is given to a corona or flame pretreatment by means of which the desired surface energies may be achieved. The surface energies should be in a range of 25-50 mN/m, preferably 30-45 mN/m.

Further suitable backing materials include impregnated and highly:sized papers with defined creping, having tensile strengths which satisfy the desired requirements. Depending on the desired application, it is possible to use both papers with greater machine direction stretchability than cross direction stretchability and papers with greater cross direction stretchability than machine direction stretchability, in both bleached and environment-friendly unbleached versions.

All percentages are by weight

### EXAMPLES

### Example 1

A dispersion adhesive composition composed of 75 Mol % of a carboxylated styrene/butadiene dispersion having a butadiene content of more than 70 Mol % (XZ 91979.00, styrene/butadiene dispersion from Dow) and 25 Mol % of natural rubber latex (low ammonia centrifuge latex) is coated continuously with a layer thickness of 25 g/m² onto a polyester film, using a wire doctor. The percentages are based on the solids content.

Technical conditions:

Machine: pilot coating plant

Applicator: wire doctor

Backing web speed: 3.5 m/min

The coating material is subsequently dried thermally:

Drying (suspension nozzle drier): zone 1: 100° C. zone 2: 120° C.

The bale material is then cut into rolls.

Adhesive-technical data (fresh state):

Bond strength/steel: 1.2 N/cm

Shear stability/steel (13×20 mm, 1 kp): >20 000 min

Microshear path (40° C., 3N): 7 μm

Thermoshear path (5° C./min, 3N, in ° C.): >200° C.

### Example 2

A dispersion adhesive composition composed of 50 Mol % of a carboxyllated styrene/butadiene dispersion having a butadiene content of more than 70 Mol % (XZ 91979.00, styrene/butadiene dispersion from Dow) and 50 Mol % of natural rubber latex (low ammonia centrifuge latex) is coated continuously with a layer thickness of 25 g/m² onto a polyester film, using a wire doctor. The percentages are based on the solids content.

Technical conditions:

Machine: pilot coating plant

Applicator: wire doctor Backing web speed: 3.5 m/min

The coating material is subsequently dried thermally:

Drying (suspension nozzle drier):

zone 1: 100° C.

zone 2: 120° C.

The bale material is then cut into rolls.

Adhesive-technical data (fresh state):

Bond strength/steel: 0.55 N/cm

Shear stability/steel (13×20 mm, 1 kp): >20 000 min

Microshear path (40° C., 3N): 5 μm

Thermoshear path (5° C./min, 3N, in ° C.): >200° C.

What is claimed is:

1. An adhesive tape for attachment to a substrate having a backing and a cohesive adhesive composition applied thereto,
wherein the cohesive adhesive composition is a dried blend of
(i) a styrene—butadiene dispersion having a butadiene content of more than 55 Mol % and
(ii) a water-based natural rubber latex, and
wherein the cohesive adhesive blend is free from tackifier resins so as to leave no residual adhesive during detachment of the tape from the substrate.

2. The adhesive tape as claimed in claim 1, wherein the natural rubber latex has either a low concentration of ammonia latex or a high concentration of ammonia latex.

3. The adhesive tape as claimed in claim 1, wherein the adhesive composition is chemically crosslinkable with a compound selected from the group consisting of aluminum chelate, titanium chelate, metal complexes, isocyanates and epoxy.

4. The adhesive tape as claimed in claim 1, wherein the adhesive composition is physically crosslinkable with electron beam curing (EBC).

5. The adhesive tape as claimed in claim 1, wherein the adhesive composition further comprises an aging inhibitor and a UV stabilizer.

6. The adhesive tape as claimed in claim 1, wherein the backing is selected from the group consisting of a polyolefin, polyester, PVC and paper.

7. The adhesive tape as claimed in claim 1, wherein the adhesive composition has been coated onto the backing at an application rate of 10-120 g/m².

8. The adhesive tape as claimed in claim 1, wherein the backing is physically surface treated for improving anchoring of the adhesive composition to the backing.

9. The adhesive tape as claimed in claim 1, wherein the backing is pretreated with a primer for improving anchoring of the adhesive composition to the backing.

10. The adhesive tape as claimed in claim 1, wherein the styrene-butadiene dispersion is a carboxylated styrene-butadiene dispersion.

11. The adhesive tape as claimed in claim 1, wherein the natural rubber latex in the adhesive composition is in the range of about 5-80 Mol %, based on a total solids content of the adhesive composition.

12. The adhesive tape as claimed in claim 11, wherein the natural rubber latex in the adhesive composition is in the range of 20-50 Mol %, based on the total solids content of the adhesive composition.

13. A method of protecting a surface comprising the steps of applying an adhesive tape according to claim 1 to the surface, and thereafter detaching the adhesive tape from said surface.
